(19) United States
(12) Patent Application Publication
(10) Pub. No.: US 2020/0347276 A1
(43) Pub. Date: Nov. 5, 2020

(54) THERMALLY CONDUCTIVE ADHESIVES AND ARTICLES, AND METHODS OF MAKING SAME

(71) Applicant: 3M INNOVATIVE PROPERTIES COMPANY, St. Paul, MN (US)

(72) Inventors: Li Yao, Woodbury, MN (US); Richard Yufeng Liu, Woodbury, MN (US)

(21) Appl. No.: 16/760,465

(22) PCT Filed: Dec. 19, 2018
(86) PCT No.: PCT/IB2018/060378

§ 371 Date: Apr. 30, 2020

Related U.S. Application Data
(60) Provisional application No. 62/609,503, filed on Dec. 22, 2017.

(51) Int. Cl. C09J 11/04; C09J 7/38; C09J 7/10; C09K 5/14; C08L 53/00; B32B 27/36; B32B 27/08

(52) U.S. Cl. CPC C09J 11/04; B32B 2255/10; C09J 7/10; C09K 5/14; C08L 53/00; B32B 27/36; B32B 27/08; C09J 2301/408; C09J 2301/414; C09J 2453/00; C09J 2301/302; C08L 2312/00; B32B 2405/00; B32B 2255/26; C09J 7/387

(57) ABSTRACT

A thermally conductive adhesive is provided. The thermally conductive adhesive includes a polyolefin block-containing copolymer, a tackifier, and a thermally conductive filler. The thermally conductive adhesive is a crosslinked pressure sensitive adhesive, plus exhibits a high elongation at break. Additionally provided are thermally conductive articles, including a thermally conductive adhesive on a substrate and a thermally conductive pad. A method of making a thermally conductive adhesive is also provided, including exposing a composition to radiation to crosslink the composition.

### FIELD

The present disclosure relates to thermally conductive materials and methods of making the materials. Generally, the thermal conductive materials are based on heat conducting fillers dispersed in a crosslinked block copolymer resin system.

### SUMMARY

In a first aspect, the present disclosure provides a thermally conductive adhesive. The thermally conductive adhesive includes 10 to 50 wt. % of a polyolefin block-containing copolymer; 10 to 50 wt. % of a tackifier; and 20 to 70 wt. % of a thermally conductive filler. The thermally conductive adhesive is a crosslinked pressure sensitive adhesive and exhibits an elongation at break of 200% or greater.

In a second aspect, a thermally conductive article is provided. The thermally conductive article includes the thermally conductive adhesive according to the first aspect, disposed on a substrate.

In a third aspect, a thermally conductive pad is provided. The thermally conductive pad includes 10 to 50 wt. % of a polyolefin block-containing copolymer; 10 to 50 wt. % of a tackifier; and 20 to 70 wt. % of a thermally conductive filler. The polyolefin block-containing copolymer is crosslinked, the thermally conductive pad is not a pressure sensitive adhesive; and the thermally conductive pad exhibits an elongation at break of 200% or greater.

In a fourth aspect, a method of making a thermally conductive adhesive is provided. The method includes: obtaining a composition; and exposing the composition to actinic radiation to crosslink the composition and form the thermally conductive adhesive. The composition includes 10 to 50 wt. % of a polyolefin block-containing copolymer; 10 to 50 wt. % of a tackifier; 20 to 70 wt. % of a thermally conductive filler; and a photoinitiator. The thermally conductive adhesive is a pressure sensitive adhesive and exhibits an elongation at break of 200% or greater.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 is a schematic cross-sectional view of an exemplary article according to the present disclosure.

FIG. 2 is a flow chart of an exemplary method of making a thermally conductive adhesive according to the present disclosure.

FIG. 3 is a graph of elongation (e.g., strain) for Example 4, as a function of load force.

### DETAILED DESCRIPTION

Thermally conductive materials (adhesives, pads, etc.) are a key component for reliable performance of high performance electronic devices (e.g., batteries). In some applications, high thermal conductivity is required in combination with mechanical performance. For example, an application may require one or more of compressibility, adhesion, ability to adjust to tolerance variations, and adequate mechanical performance (e.g., toughness). There remains a need for improved thermally conductive materials.

In a first aspect, a thermally conductive adhesive is provided. The thermally conductive adhesive advantageously exhibits a high elongation at break despite being crosslinked. In particular, the thermally conductive adhesive comprises:

a. 10 to 50 wt. % of a polyolefin block-containing copolymer;

b. 10 to 50 wt. % of a tackifier; and

c. 20 to 70 wt. % of a thermally conductive filler;

wherein the thermally conductive adhesive is a crosslinked pressure sensitive adhesive and wherein the thermally conductive adhesive exhibits an elongation at break of 200% or greater.

Pressure-sensitive adhesives are normally tacky at room temperature and can be adhered to a surface by application of light finger pressure and thus may be distinguished from other types of adhesives that are not pressure-sensitive. A general description of pressure-sensitive adhesives may be found in the Encyclopedia of Polymer Science and Engineering, Vol. 13, Wiley-Interscience Publishers (New York, 1988). Additional description of pressure-sensitive adhesives may be found in the Encyclopedia of Polymer Science and Technology, Vol. 1, Interscience Publishers (New York, 1964). “Pressure sensitive adhesive” or “PSA”, as used herein, refers to a viscoelastic material that possesses the following properties: (1) aggressive and permanent tack, (2) adherence to a substrate other than a fluorothermoplastic film with no more than finger pressure, and (3) sufficient cohesive strength to cleanly release from the substrate. A pressure-sensitive adhesive may also meet the Dahlquist criterion described in Handbook of Pressure-Sensitive Adhesive Technology, D. Satas, 2^{nd} ed., page 172 (1989). This criterion defines a pressure-sensitive adhesive as one having a one-second creep compliance of greater than 1×10⁻⁶ cm²/dyne at its use temperature (for example, at temperatures in a range of from 15° C. to 35° C.).

A thermally conductive adhesive of the present disclosure comprises one or more different thermally conductive fillers (also referred to as heat conducting fillers) dispersed in a resin system. As used herein, “resin system” refers to the polyolefin block-containing copolymer(s), the tackifier(s), and if present, plasticizer(s). Additional components may also be present, including those commonly found in thermally conductive materials, however, these items are referred to as “additives” distinct from the resin system. As a pressure sensitive adhesive, it is advantageously not necessary for the thermally conductive adhesive to be activated prior to use (e.g., by heat as in a “hot melt” or by mixing multiple components as in a “two-part” adhesive).

The resin system comprises a polyolefin block-containing copolymer. Suitable block copolymers include at least one glassy block and at least one rubbery block. A glassy block exhibits a T_{g} of greater than room temperature, e.g., 20° C. or greater or 25° C. or greater. In some embodiments, the T_{g} of the glassy block is 40° C. or greater, 60° C. or greater, 80° C. or greater, or even 100° C. or greater. In some literature, glassy blocks have also been referred to as hard blocks or segments. Generally, a rubbery block exhibits a glass transition temperature (T_{g}) of less than room temperature, e.g., 20° C. or 15° C. or less. In some embodiments, the T_{g} of the rubbery block is 0° C. or less, or even −10° C. or less. In some embodiments, the T_{g} of the rubbery block is −40° C. or less, or even −60° C. or less. In some literature, rubbery blocks have also been referred to as soft blocks or segments.

In some embodiments, the resin system comprises at least one linear block copolymer, which can be described by the formula

R-(G)ₘ

wherein R represents a rubbery block, G represents a glassy block, and m, the number of glassy blocks, is 1 or 2. In some embodiments, m is one, and the linear block copolymer is a diblock copolymer comprising one rubbery block and one glassy block. In some embodiments, m is two, and the linear block copolymer comprises two glassy endblocks and one rubbery midblock, i.e., the linear block copolymer is a triblock copolymer. In some embodiments, m is three, and the linear block copolymer comprises two glassy endblocks and two rubbery midblocks, i.e., the linear block copolymer is a tetrablock copolymer. In some embodiments, the rubbery blocks and the glassy blocks are distributed in star shaped chain architecture. In some embodiments, the rubbery blocks and the glassy blocks are distributed in branched chain architecture. In some embodiments, the rubbery blocks and the glassy blocks are distributed in random block architecture in which there are multiple blocks of various length of either rubbery blocks or glassy blocks.

In some embodiments, the rubbery polyolefin block comprises a polymerized conjugated diene, a hydrogenated derivative of a polymerized conjugated diene, or combinations thereof. In some embodiments, the conjugated dienes comprise 2 to 12 carbon atoms. Exemplary conjugated dienes include isoprene, ethylene, propene, butadiene, butene, octene, pentene, hexene, or a combination thereof. The polymerized conjugated dienes may be used individually or as copolymers with each other. In some embodiments, the conjugated diene is selected from the group consisting of isoprene, butadiene, ethylene butadiene copolymers, ethylene propylene copolymers, and combinations thereof. In some favored embodiments, the polyolefin block-containing copolymer comprises isoprene as a rubbery block. In some embodiments, the rubbery block has a length that ranges from 10 to 1000 repeating units, 20 to 800 repeating units, or 30 to 600 repeating units.

In some embodiments, at least one glassy block comprises a polymerized monovinyl aromatic monomer. In some embodiments, both glassy blocks of a triblock copolymer comprise a polymerized monovinyl aromatic monomer. In some embodiments, the monovinyl aromatic monomers comprise 8 to 18 carbon atoms. Exemplary monovinyl aromatic monomers include styrene, alpha-methyl styrene, methyl styrene, dimethylstyrene, ethylstyrene, diethyl styrene, t-butylstyrene, di-n-butylstyrene, isopropylstyrene, other alkylated-styrenes, styrene analogs, and styrene homologs. In certain preferred embodiments, the monovinyl aromatic monomer is styrene. In some embodiments, the block length for the glassy block ranges from 5 to 200 repeating units, 10 to 150 repeating units, or 20 to 100 repeating units.

In certain embodiments, the polyolefin block-containing copolymer comprises styrene in an amount of 5 wt. % or greater, 7 wt. % or greater, 10 wt. % or greater, 12 wt. % or greater, or 15 wt. % or greater; and 50 wt. % or less, 45 wt. % or less, 40 wt. % or less, 35 wt. % or less, 30 wt. % or less, 25 wt. % or less, or 20 wt. % or less of the total polyolefin block-containing copolymer. Stated another way, the polyolefin block-containing copolymer can comprise styrene in an amount of 5 to 50 wt. %, 10 to 30 wt. %, or 12 to 20 wt. % of the total polyolefin block-containing copolymer.

In some embodiments, a linear block copolymer is diblock copolymer. In some embodiments, the diblock copolymer is selected from the group consisting of styrene-isoprene, or styrene-butadiene. In some embodiments, the linear block copolymer is a triblock copolymer. In some embodiments, the triblock copolymer is selected from the group consisting of styrene-isoprene-styrene, styrene-butadiene-styrene, styrene-ethylene-butadiene-styrene, styrene-ethylene-propylene, styrene-ethylene-butadiene and combinations thereof. In some embodiments, multiblock copolymers are selected from the aforementioned blocks and can be in the chain architecture of star-shaped, branched, or randomly distributed. These olefin block copolymers are commercially available, e.g., those under the trade name VECTOR available from Dexco Polymer LP (Houston, Tex.); and those available under the trade name KRATON available from Kraton Polymers U.S. LLC (Houston, Tex.). As manufactured and/or purchased, triblock copolymers may contain some fraction of diblock copolymer as well.

In some embodiments, the resin system comprises at least one star block copolymer, sometimes referred to as a multi-arm block copolymer. A star block copolymer may be described by the formula

Y-(Q)ₙ

wherein Q represents an arm of the multi-arm block copolymer; n represents the number of arms and is a whole number of at least 3, i.e., the multi-arm block copolymer is a star block copolymer. Y is the residue of a multifunctional coupling agent. In some embodiments, n ranges from 3-10. In some embodiments, n ranges from 3-5. In some embodiments, n is 4. In some embodiments, n is equal to 6 or more.

Each arm, Q, independently has the formula G-R, wherein G is a glassy block; and R is a rubbery block. Exemplary rubbery blocks include polymerized conjugated dienes, such as those described above, hydrogenated derivatives of a polymerized conjugated diene, or combinations thereof. In some embodiments, the rubbery block of at least one arm comprises a polymerized conjugated diene selected from the group consisting of isoprene, butadiene, ethylene butadiene, ethylene propylene, ethylene octane, ethylene hexene copolymers, and combinations thereof. In some embodiments, the rubbery block of each arm comprises a polymerized conjugated diene selected from the group consisting of isoprene, butadiene, ethylene butadiene, ethylene propylene, ethylene octane, ethylene hexene copolymers, and combinations thereof.

Exemplary glassy blocks include polymerized monovinyl aromatic monomers, such as those described above. In some embodiments, the glassy block of at least one arm is styrene, and in some embodiments, the glassy block of each arm is styrene.

In some embodiments, the polyolefin block-containing copolymer is selected from styrene-isoprene-styrene (SIS) copolymer, styrene-butadiene-styrene (SBS) copolymer, styrene-isoprene-butadiene-styrene (SIBS) copolymer, styrene-ethylene-butadiene-styrene (SEBS) copolymer, styrene-ethylene-propylene-styrene (SEPS) copolymer, styrene-butadiene-rubber (SBR) copolymer, or combinations thereof.

It is generally desirable to have a thermally conductive adhesive that exhibits viscoelastic behavior at room temperature (e.g., 20-25° C.). In some embodiments, the desired viscoelastic behavior may be achieved by selecting the appropriate block copolymer(s) and combining them with one or more tackifier(s), plasticizers(s), and combinations thereof.

The resin systems of the thermally conductive adhesives according to the present disclosure include at least one tackifier. Tackifiers are materials that are compatible with at least one block of a block copolymer and which increase the T_{g} of that block. As used herein, a tackifier is “compatible” with a block if it is miscible with that block. A tackifier is “primarily compatible” with a block if it is at least miscible with that block, although it may also be miscible with other blocks. For example, a tackifier that is primarily compatible with a rubbery block will be miscible with the rubbery block, but may also be miscible with a glassy block. Similarly, a tackifier that is primarily compatible with a glassy block is miscible with the glassy block and may be miscible with a rubbery block.

The concept of miscibility is well known in the art, as are methods for evaluating miscibility. Generally, the miscibility of a tackifier with a block can be determined by measuring the effect of the tackifier on the T_{g} of that block. If a tackifier is miscible with a block it will alter (e.g., increase) the T_{g} of that block.

Generally, tackifier resins having relatively low solubility parameters tend to associate with the rubbery blocks; however, their solubility in the glassy blocks tends to increase as the molecular weights or softening points of these resins are lowered. Exemplary tackifiers that are primarily compatible with the rubbery blocks include polymeric terpenes, hetero-functional terpenes, coumarone-indene resins, rosin acids, esters of rosin acids, disproportionated rosin acid esters, hydrogenated C5 aliphatic resins, C9 hydrogenated aromatic resins, C5-C9 aliphatic/aromatic resins, dicyclopentadiene resins, hydrogenated hydrocarbon resins arising from C5-C9 and dicyclopentadiene precursors, hydrogenated styrene monomer resins, and blends thereof. In some favored embodiments, the tackifier comprises a C5-C9 hydrocarbon.

Generally, tackifier resins having relatively high solubility parameters tend to associate with the glassy blocks; however, their solubility in the rubbery blocks tends to increase as the molecular weights or softening points of these resins are lowered. Exemplary tackifiers that are primarily compatible with the glassy blocks include coumarone-indene resins, rosin acids, esters of rosin acids, disproportionated rosin acid esters, C9 aromatics, alpha-methyl styrene, C5-C9 aromatic-modified aliphatic hydrocarbons, and blends thereof. One exemplary suitable tackifier is commercially available from Cray Valley (Exton, Pa.) under the trade designation WINGTACK PLUS flake/pastille, and is an aromatically modified C5 hydrocarbon resin. Another suitable tackifier includes for instance, WINGTACK 10 liquid aliphatic C-5 petroleum hydrocarbon tackifying resin commercially available from Cray Valley USA, LLC (Exton, Pa.).

In some embodiments, the resin system includes at least one plasticizer. Plasticizers are materials that are compatible with at least one block of a block copolymer and which decrease the T_{g} of that block. Generally, a plasticizer that is compatible with a block will be miscible with that block and will alter (e.g., lower) the T_{g} of that block. Exemplary plasticizers include naphthenic oils, paraffinic oil, liquid polybutene resins, polyisobutylene resins, and liquid isoprene polymers.

The relative amounts of block copolymers, tackifiers, and (optional) plasticizers will depend on the specific materials selected, their properties (such as T_{g}, modulus, and solubility parameter), and the desired properties of the thermally conductive adhesives. In some embodiments, the thermally conductive adhesive comprises 10 percent by weight (10 wt. %) or greater block copolymer(s) based on the total weight of the thermally conductive adhesive, e.g., 15 wt. % or greater or 20 wt. % or greater. In some embodiments, the thermally conductive adhesive comprises up to 60 wt. % block copolymer(s) based on the total weight of the thermally conductive adhesive, e.g., up to 55 wt. %, or even up to 50 wt. %.

In some embodiments, the thermally conductive adhesive comprises 10 wt. % or greater tackifier(s) based on the total weight of the thermally conductive adhesive, e.g., 15 wt. % or greater, 20 wt. % or greater, 25 wt. % or greater, or even 30 wt. % or greater. In some embodiments, the resin system comprises 60 wt. % or less tackifier(s) based on the total weight of the thermally conductive adhesive, e.g., no greater than 50 wt. %, or even no greater than 40 wt. %.

In some embodiments, the thermally conductive adhesive comprises 10 wt. % or greater plasticizer(s) based on the total weight of the thermally conductive adhesive, e.g., 15 wt. % or greater, 20 wt. % or greater, or even 30 wt. % or greater. In some embodiments, the thermally conductive adhesive, e.g., up to 50 wt. %, or even up to 40 wt. %.

In addition to the resin system, the thermally conductive adhesive of the present disclosure comprises at least one thermally conductive (i.e., heat conducting) filler. These fillers are distributed (e.g., dispersed) in the resin system. Suitable thermally conductive fillers are known in the art, and may comprise a ceramic, a metal oxide, a metal hydroxide, or combinations thereof. Exemplary thermally conductive fillers include, e.g., diamond, polycrystalline diamond, silicon carbide, alumina, aluminum trihydrate, aluminum carbide, aluminum, boron nitride (hexagonal or cubic), boron carbide, silica, silicon nitride, magnesium oxide, beryllium oxide, titanium oxide, zirconium oxide, barium hydroxide, calcium hydroxide, dawsonite, hydrotalcite, zinc borate, calcium aluminate, zirconium oxide hydrate, graphite, amorphous carbon, zinc oxide, nickel, tungsten, silver, and any combination thereof. In some embodiments, the thermally conductive fillers are selected from the group consisting of aluminum trihydrate (ATH), boron nitride (BN), and combinations thereof. In some embodiments, the boron nitride is hexagonal boron nitride (h-BN).

The thermally conductive filler may be in the form of particles, fibers, flakes, other conventional forms, or combinations thereof. Often, the thermally conductive filler is solid (as opposed to hollow), thus in certain embodiments, the thermally conductive adhesive comprises 20 wt. % to 90 wt. % of at least one solid thermally conductive filler. In certain embodiment, the thermally conductive filler comprises a surface that is not treated (e.g., an untreated surface), as opposed to a filler that has been subjected to a surface treatment (e.g., to functionalize the filler surface). Generally, the type of fillers and their amounts can be selected to achieve the desired thermal conductivity of the thermally conductive adhesive. Generally, the thermally conductive filler may be present in the thermally conductive adhesive in an amount of 20 percent or more by weight, based on the total weight of the thermally conductive adhesive to provide a minimum amount of thermal conductivity. In other embodiments, thermally conductive filler may be present in amounts of at least 25 wt. %, 30 wt. %, 40 wt. %, 50 wt. %, 60 wt. %, or even 70 wt. % by weight. In other embodiments, thermally conductive filler may be present in the thermally conductive adhesives in an amount of up to 90 wt. %, 80 wt. %, 70 wt. %, 60 wt. % or 50 wt. %. For example, in some embodiments, the thermally conductive filler may be present in an amount from e.g., 20 wt. % to 90 wt. %, 20 wt. % to 70 wt. %, 30 wt. % to 90 wt. %, 50 wt. % to 90 wt. %, or even 50 wt. % to 70 wt. %, based on the total weight of the thermally conductive adhesive. High loadings of thermally conductive filler tend to make the thermally conductive adhesive difficult to process.

In some embodiments, the thermally conductive fillers can be in the form of single crystal platelets or agglomerates formed from these single crystals. In some embodiments, the boron nitride comprises hexagonal boron nitride (h-BN). Single crystal boron nitride can vary in particle size from sub-micron up to D50 of 50 micrometers (μm) as measured by a laser diffraction particle size analyzer (e.g., a MASTERSIZER available from Malvern Instruments (Worcestershire, UK)). Larger sizes can be used in some embodiments. Increasing particle size is generally preferred for increasing the thermal conductivity whereas smaller particle sizes generally have lower production costs. In some embodiments, agglomerates are used to attain even higher particle sizes.

Single crystal h-BN has a strong anisotropy in thermal conductivity with up to 400 W/mK in plane (e.g., the x- and y-axes) and as low as 4 W/mK through plane (e.g., the z-axis). By alignment of the plate-like particles in the melt flow, anisotropic thermal properties can be created in the resulting composite (e.g., thermally conductive adhesive). Agglomerates help to reduce the anisotropy with the degree of anisotropy dependent on the particle alignment inside the agglomerate.

Additional components, referred to herein as “additives,” may be included in the thermally conductive adhesive. Suitable additional components include those known in the art. Exemplary additional components include fillers such as electrically conductive fillers, silica, talc, calcium carbonate and the like; pigments, dyes, or other colorants; glass or plastic beads or bubbles; core-shell particles, dispersants, stabilizers (including, e.g., thermal and UV stabilizers), rheology modifiers, flame retardants, and foaming agents including thermal or chemical blowing agents and expandable microspheres. The selection of individual additives as well as combinations of additives, including their relative amounts depends on the desired end use requirements. Generally, such selections are within the knowledge of one of ordinary skill in the art.

An initiator is typically added to the composition to assist in crosslinking the polyolefin block-containing copolymer, e.g., a thermal initiator, a photoinitiator, or both. Any suitable thermal initiator or photoinitiator known for free radical polymerization reactions can be used. The initiator is typically present in an amount in the range of 0.01 to 5 wt. %, in the range of 0.01 to 2 wt. %, in the range of 0.01 to 1 wt. %, or in the range of 0.01 to 0.5 wt. %, based on a total weight of thermally conductive adhesive.

In some embodiments, a thermal initiator is used. Thermal initiators can be water-soluble or water-insoluble (i.e., oil-soluble) depending on the particular polymerization method used. Suitable water-soluble initiators include, but are not limited to, persulfates such as potassium persulfate, ammonium persulfate, sodium persulfate, and mixtures thereof; an oxidation-reduction initiator such as the reaction product of a persulfate and a reducing agent such as a metabisulfite (e.g., sodium metabisulfite) or a bisulfate (e.g., sodium bisulfate); or 4,4′-azobis(4-cyanopentanoic acid) and its soluble salts (e.g., sodium, potassium). Suitable oil-soluble initiators include, but are not limited to, various azo compounds such as those commercially available under the trade designation VAZO from E. I. DuPont de Nemours Co., Wilmington, Del., including VAZO 67, which is 2,2′-azobis(2-methylbutane nitrile), VAZO 64, which is 2,2′-azobis(isobutyronitrile), and VAZO 52, which is (2,2′-azobis(2,4-dimethylpentanenitrile); and various peroxides such as benzoyl peroxide, cyclohexane peroxide, lauroyl peroxide, and mixtures thereof.

Alternatively, a photoinitiator can be used to crosslink the polyolefin block-containing copolymer. Exemplary photoinitiators include benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Ludwigshafen, Germany) or under the trade designation ESACURE KB-1 from Sartomer (Exton, Pa.)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1 -phenyl-1,2-propanedione-2-(0-ethoxycarbonyl)oxime. Other suitable photoinitiators include, for example, 1 -hydroxy cyclohexyl phenyl ketone (IRGACURE 184), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-moholinophenyl)butanone (IRGACURE 369), 2-methyl-1-[4-(methylthio)phenyl]-2-morpholinopropan-1-one (IRGACURE 907), and 2-hydroxy-2-methyl-1 -phenyl propan-1-one (DAROCUR 1173).

In certain embodiments, a suitable photoinitiator comprises a benzoin ether or a substituted benzoin ether; a substituted acetophenone, such as 2,2-diethoxyacetophenone or 2,2-dimethoxy-2-phenylacetophenone; a substituted alpha-ketol, such as 2-methyl-2-hydroxypropiophenone; an aromatic sulfonyl chloride, such as 2-naphthalenesulfonyl chloride; and a photoactive oxime, such as 1-phenyl-1,2-propanedione-2-(0-ethoxycarbonyl)oxime, 1-hydroxy cyclohexyl phenyl ketone (e.g., IRGACURE 184); bis(2,4,6-trimethylbenzoyl)phenylphosphineoxide; or combinations thereof.

In some embodiments, a crosslinking agent is included in a composition for reaction to form a thermally conductive adhesive. A crosslinking agent can be considered as a monomer having an ethylenically unsaturated group (e.g., a vinyl group). Advantageously, a crosslinking agent can significantly increase the cohesive strength and the tensile strength of an adhesive. A crosslinking agent generally has at least two functional groups which are capable of covalently bonding with a monomer of the polyolefin block-containing copolymer. That is, the crosslinking agent can have at least two ethylenically unsaturated groups (e.g., one or more of which are vinyl groups). Suitable crosslinking agents often have multiple (meth)acryloyl or vinyl groups. Alternatively, the crosslinking agent can have at least two groups that are capable of reacting with various functional groups (i.e., functional groups that are not ethylenically unsaturated groups) on another monomer. For example, the crosslinking agent can have multiple groups that can react with functional groups such as acidic groups on other monomers. In some favored embodiments, the crosslinking agent comprises a UV photocrosslinker.

Crosslinking agents with multiple (meth)acryloyl groups include di(meth)acrylates, tri(meth)acrylates, tetra(meth)acrylates, and penta(meth)acrylates. These crosslinking agents can be formed, for example, by reacting (meth)acrylic acid with a polyhydric alcohol (i.e., an alcohol having at least two hydroxyl groups). The polyhydric alcohol often has two, three, four, or five hydroxyl groups. Mixtures of crosslinking agents may also be used.

Optionally, crosslinking agents contain at least two (meth)acryloyl groups. Exemplary crosslinking agents with two acryloyl groups include, but are not limited to, 1,2-ethanediol diacrylate, 1,3 -propanediol diacrylate, 1,9-nonanediol diacrylate, 1, 12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone. Crosslinking agents with three or four (meth)acryloyl groups include, but are not limited to, trimethylolpropane triacrylate (e.g., commercially available under the trade designation TMPTA-N from Cytec Industries, Inc., Smyrna, Ga. and under the trade designation SR-351 from Sartomer), pentaerythritol triacrylate (e.g., commercially available under the trade designation SR-444 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), di-trimethylolpropane tetraacrylate (e.g., commercially available under the trade designation SR-355 from Sartomer), and ethoxylated pentaerythritol tetraacrylate (e.g., commercially available under the trade designation SR-494 from Sartomer). An exemplary crosslinking agent with five (meth)acryloyl groups includes, but is not limited to, dipentaerythritol pentaacrylate (e.g., commercially available under the trade designation SR-399 from Sartomer).

In some embodiments, a suitable crosslinking agent is polymeric and contains at least two (meth)acryloyl groups. For example, the crosslinking agent can be poly(alkylene oxide) with at least two acryloyl groups (e.g., polyethylene glycol diacrylates commercially available from Sartomer such as SR210, SR252, and SR603) or poly(urethanes) with at least two (meth)acryloyl groups (e.g., polyurethane diacrylates such as CN9018 from Sartomer). As the molecular weight of the crosslinking agent increases, the resulting copolymer tends to have a higher elongation before breaking.

Other types of crosslinking agents are available. The crosslinking agent, for example, can have multiple groups that react with functional groups such as acidic groups on other second monomers. Monomers with multiple aziridinyl groups can be used, where such monomers are reactive with carboxyl groups. For example, the crosslinking agents can be a bis-amide crosslinking agent as described in U.S. Pat. No. 6,777,079 (Zhou et al.).

In select embodiments, the crosslinking agent comprises multiple (meth)acryloyl groups selected from di(meth)acrylates, tri(meth)acrylates, tetra(meth)acrylates, and penta(meth)acrylates, or combinations thereof.

In some embodiments, thermal crosslinking agents can be used. Optionally, thermal crosslinking agents can be used in combination with accelerants or retardants. Suitable thermal crosslinking agents for use herein include, but are not limited to, isocyanates, more particularly trimerized isocyanates and/or sterically hindered isocyanates that are free of blocking agents, or epoxide compounds such as epoxide-amine crosslinking agent systems. Advantageous crosslinking agent systems and methods are described, for example, in European Patent Publication Nos. EP 2305389 (Prenzel et al.), EP 2414143 (Czerwonatis et al.), EP 2192148 (Prenzel et al.), EP 2186869 (Grinner et al.), EP 0752435 (Burmeister et al), EP 1802722 (Zoellner et al.), EP 1791921 (Zoellner et al), EP 1791922 (Zoellner et al), and EP 1978069 (Zoellner et al.). Suitable accelerant and retardant systems for use herein are described, for example, in U.S. Pat. No. 9,200,129 (Czerwonatis et al.). Thermal crosslinking agents include epoxycyclohexyl derivatives and, in particular, epoxycyclohexyl carboxylate derivatives, with particular preference to (3,4-epoxycyclohexane)methyl 3,4-epoxycyclohexylcarboxylate, commercially available from Cytec Industries Inc. under trade name UVACURE 1500.

If present, a crosslinking agent can be used in any suitable amount. In some embodiments, the crosslinking agent is present in an amount up to 5 wt. %, up to 4 wt. %, up to 3 wt. %, up to 2 wt. %, or up to 1 wt. % of the composition that reacts to form the thermally conductive adhesive. The crosslinking agent can be present, for example, in amounts of 0.01 wt. % or greater, 0.03 wt. % or greater, 0.05 wt. % or greater, 0.07 wt. % or greater, or 0.09 wt. % or greater. In some aspects, the crosslinking agent is present in an amount in a range of 0 to 5 wt. %, 0.01 to 5 wt. %, 0.05 to 5 wt. %, 0 to 3 wt. %, 0.01 to 3 wt. %, 0.05 to 3 wt. %, 0 to 1 wt. %, 0.01 to 1 wt. %, or 0.05 to 1 wt. %.

In some embodiments, an inhibitor is included, such as a free radical inhibitor. Typically, an antioxidant can act as a free radical inhibitor. Suitable antioxidants include various aryl compounds, including butylated hydroxytoluene (BHT). In addition or as an alternative, the free radical inhibitor comprises methoxyhydroquinone (MEHQ).

In certain embodiments, the crosslinked pressure sensitive adhesive comprises a reaction product of a composition comprising the polyolefin block-containing copolymer, a crosslinking agent, an initiator, and a free radical inhibitor. The composition may be formed by mixing, compounding, or extruding (e.g., hot melt processing) the components of the composition, to form a generally homogenous mixture and distribute (e.g., disperse) the thermally conductive filler in the resin system.

Aside from thermal, moisture, or photosensitive crosslinking agents, crosslinking may also be achieved using high energy electromagnetic radiation such as gamma or electron beam radiation.

Typically, the thickness (e.g., the length in the z-direction) of (e.g., a layer of) a thermally conductive adhesive is 100 micrometers (pm) or greater, 150 μm or greater, 200 μm or greater, 250 μm or greater, 300 μm or greater, or even 350 μm or greater; and 500 μm or less, 450 μm or less, or even 400 μm or less. It has unexpectedly been discovered that the polyolefin block-containing copolymer of the thermally conductive adhesive according to at least certain embodiments of the present disclosure can be successfully crosslinked using actinic radiation, despite high loadings of filler (e.g., 40 wt. % or higher) and large layer thicknesses (e.g., 250 μm or greater). The process of crosslinking is discussed in detail below with respect to the fourth aspect.

The resin system of the thermally conductive adhesive is sufficiently crosslinked to provide 10% or greater gel content of the thermally conductive adhesive, 20 wt. % or greater, 30 wt. % or greater, 40 wt. % or greater, or 50 wt. % or greater gel content; and 90% or less gel content, 80% or less, 70% or less, or 60% or less gel content of the thermally conductive adhesive. Stated another way, the thermally conductive adhesive (e.g., including a crosslinked pressure sensitive adhesive) comprises a gel content of 10 to 90% or 40 to 90%. Gel content is determined by submerging the thermally conductive adhesive in a solvent capable of dissolving the polyolefin block-containing copolymer, such as tetrahydrofuran, and calculating what percentage by weight of the thermally conductive adhesive remains at the end of the test. The gel content test method is described in detail in the Examples below.

Moreover, after crosslinking, the thermally conductive adhesive unexpectedly and advantageously exhibits an elongation at break of 200% or greater, 250% or greater, 300% or greater, 350% or greater, or even 400% or greater; and 1000% or less, 900% or less, 800% or less, 700% or less, or 600% or less.

In many embodiments, the thermally conductive adhesive exhibits a through-plane (e.g., z-axis) thermal conductivity of 0.25 W/m·K or greater, 0.30 W/m·K or greater, 0.35 W/m·K or greater, 0.40 W/m·K or greater, 0.45 W/m·K or greater, or even 0.50 W/m·K or greater. A suitable method for determining through-plane thermal conductivity is described in detail in the Examples below.

Similarly, in many embodiments, the thermally conductive adhesive exhibits an in-plane (e.g., x- and y-axes) thermal conductivity of 2.75 watts per meter-kelvin (W/m·K) or greater, 3.0 W/m·K or greater, 3.25 W/m·K or greater, 3.5 W/m·K or greater, 3.75 W/m·K or greater, 4.0 W/m·K or greater, 4.25 W/m·K or greater, 4.5 W/m·K or greater, 4.75 W/m·K or greater, 5.0 W/m·K or greater, 5.5 W/m·K or greater, 6.0 W/m·K or greater, or even 6.5 W/m·K or greater. A suitable method for determining in-plane thermal conductivity is described in detail in the Examples below.

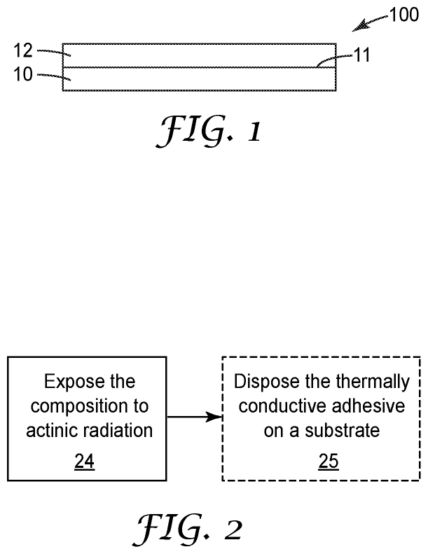

In a second aspect, a thermally conductive article is provided. The thermally conductive article includes the thermally conductive adhesive according to the first aspect, disposed on a substrate, such as a release liner. Referring to FIG. 1, a thermally conductive article comprises a substrate 10 having a first major surface 11, and a thermally conductive adhesive 12 disposed on at least a portion of the first major surface 11 of the substrate 10.

Such a substrate 10 is often a release liner, and may comprise a release surface on the first major surface 11, which release surface is suitable for releasing of a pressure-sensitive adhesive therefrom. A release surface can be provided by any suitable material (or, by any suitable treatment of the surface of the material of which a release liner is made). Such a release surface might be e.g., any suitable coating, for example wax or the like. Or, any suitable high molecular weight polymeric layer (e.g., coating) might be used, e.g. a polyolefin layer such as polyethylene and so on. It will be appreciated that numerous layers and treatments can be suitable for such use.

The substrate (e.g., release liner) 10 can be of a variety of forms including, e.g., sheet, web, tape, and film. Examples of suitable materials include, e.g., paper (e.g., kraft paper, poly-coated paper and the like), polymer films (e.g., polyethylene, polypropylene, and polyester), composite liners, and combinations thereof. Release liners can optionally include a variety of markings and indicia including, e.g., lines, art work, brand indicia, and other information.

In some embodiments, the substrate 10 may not be a release liner. In such embodiments, the thermally conductive adhesive 12 may be bonded permanently to the substrate 10 (meaning that the adhesive layer and the substrate cannot be removed from each other without unacceptably damaging or destroying one or both of them). In such embodiments, the substrate 10 can be any backing (i.e., a tape backing) suitable for making any suitable kind of tape (masking tape, sealing tape, strapping tape, filament tape, packaging tape, duct tape, electrical tape, medical/surgical tape, and so on). The backing 10 can take any suitable form including, e.g. polymer films, paper, cardboard, stock card, woven and nonwoven webs, fiber reinforced films, foams, composite film-foams, and combinations thereof. The backing 10 may be comprised of any suitable material including e g fibers, cellulose, cellophane, wood, foam, and synthetic polymeric materials including, e.g., polyolefins (e.g., polyethylene, polypropylene, and copolymers and blends thereof); vinyl copolymers (e.g., polyvinyl chlorides, polyvinyl acetates); olefinic copolymers (e.g., ethylene/methacrylate copolymers, ethylene/vinyl acetate copolymers, acrylonitrile-butadiene-styrene copolymers, and so on); acrylic polymers and copolymers; and polyurethanes. Blends of any of these may be used. In particular embodiments, oriented (e.g., uniaxially or biaxially oriented) materials, such as e.g. biaxially-oriented polypropylene may be used.

In a third aspect, a thermally conductive pad is provided. The thermally conductive pad is generally the same as the thermally conductive adhesive except that it is not a pressure sensitive adhesive. In particular, the thermally conductive pad comprises:

a. 10 to 50 wt. % of a polyolefin block-containing copolymer;

b. 10 to 50 wt. % of a tackifier; and

c. 20 to 70 wt. % of a thermally conductive filler;

wherein the polyolefin block-containing copolymer is crosslinked; wherein the thermally conductive pad is not a pressure sensitive adhesive; and wherein the thermally conductive pad exhibits an elongation at break of 200% or greater.

The disclosure above with respect to the polyolefin block-containing copolymer, tackifier, thermally conductive filler, crosslinking agents, additives, dimensions, physical properties, etc., also apply to the thermally conductive pad. The thermally conductive pad may be used in applications in which thermal conductivity is required, but not adhesion. In certain embodiments of thermally conductive materials, high filler loading can decrease the tackiness of the material such that it no longer meets the criteria of a pressure sensitive adhesive as described above. Any minimal tackiness present on a surface of the thermally conductive pad may assist in providing good wet-out of the surface to a surface with which it is contacted. Such advantageous wet-out might improve the transfer of heat between the thermally conductive pad and another surface.

In a fourth aspect, a method of making a thermally conductive adhesive is provided. In particular, the method of making a thermally conductive adhesive comprises:
a. obtaining a composition comprising:
   i. 10 to 50 wt. % of a polyolefin block-containing copolymer;
   ii. 10 to 50 wt. % of a tackifier;
   iii. 20 to 70 wt. % of a thermally conductive filler; and
   iv. a photoinitiator; and
b. exposing the composition to actinic radiation to crosslink the composition and form the thermally conductive adhesive, wherein the thermally conductive adhesive is a pressure sensitive adhesive and wherein the thermally conductive adhesive exhibits an elongation at break of 200% or greater.

For example, referring to FIG. 2, the method comprises exposing the composition to actinic radiation 24 to crosslink the composition and form the thermally conductive adhesive; and optionally disposing the thermally conductive adhesive on a substrate 25. Hence, in some embodiments, the method comprises disposing the thermally conductive adhesive on (e.g., at least a portion of) a substrate. The substrate can be any of the substrates described above with respect to the article of the second aspect. In certain favored embodiments, the substrate comprises a release liner. The disclosure above with respect to the polyolefin block-containing copolymer, thermally conductive filler, crosslinking agents, additives, dimensions, physical properties, etc., also applies to the thermally conductive adhesive formed using the method according to this aspect.

Suitable actinic radiation includes electromagnetic radiation in the infrared region, visible region, ultraviolet region, or a combination thereof. In certain embodiments, the actinic radiation comprises a peak wavelength between 170 nm and 500 nm, inclusive. Alternatively, the actinic radiation comprises an electronic beam (i.e., e-beam). Irradiation can be accomplished using any convenient radiation source, such as mercury vapor lamps, light emitting diodes (LEDs), lasers, fluorescent lamps comprising ultraviolet light-emitting phosphors, argon glow lamps, tungsten halogen lamps, xenon and mercury arc lamps, incandescent lamps, and germicidal lamps. Preferred are high-intensity light sources having a lamp power density of at least 80 mW/cm² and more preferably of at least 120 mW/cm².

Advantageously, the method can be used to hot melt process a thermally conductive adhesive, thus in certain embodiments the composition is essentially free of solvent.

Various embodiments are provided that include a thermally conductive adhesive, a thermally conductive article, a thermally conductive pad, and a method of making a thermally conductive adhesive.

Embodiment 1 is a thermally conductive adhesive. The thermally conductive adhesive includes: 10 to 50 wt. % of a polyolefin block-containing copolymer; 10 to 50 wt. % of a tackifier; and 20 to 70 wt. % of a thermally conductive filler. The thermally conductive adhesive is a crosslinked pressure sensitive adhesive and the thermally conductive adhesive exhibits an elongation at break of 200% or greater.

Embodiment 2 is the thermally conductive adhesive of embodiment 1, wherein the polyolefin-block comprises isoprene, ethylene, propene, butadiene, butene, octene, pentene, hexene, or a combination thereof.

Embodiment 3 is the thermally conductive adhesive of embodiment 1 or embodiment 2, wherein the polyolefin-block comprises isoprene.

Embodiment 4 is the thermally conductive adhesive of any of embodiments 1 to 3, wherein the polyolefin block-containing copolymer comprises styrene.

Embodiment 5 is the thermally conductive adhesive of any of embodiments 1 to 4, wherein the polyolefin block-containing copolymer is selected from styrene-isoprene-styrene (SIS) copolymer, styrene-butadiene-styrene (SBS) copolymer, styrene-isoprene-butadiene-styrene (SIBS) copolymer, styrene-ethylene-butadiene-styrene (SEBS) copolymer, styrene-ethylene-propylene-styrene (SEPS) copolymer, styrene-butadiene-rubber (SBR) copolymer, or combinations thereof.

Embodiment 6 is the thermally conductive adhesive of any of embodiments 1 to 5, wherein the polyolefin block-containing copolymer comprises styrene in an amount of 5 to 50 wt. %, 10 to 30 wt. %, or 12 to 20 wt. % of the total polyolefin block-containing copolymer.

Embodiment 7 is the thermally conductive adhesive of any of embodiments 1 to 6, wherein the thermally conductive filler includes a ceramic, a metal oxide, a metal hydroxide, or combinations thereof.

Embodiment 8 is the thermally conductive adhesive of any of embodiments 1 to 7, wherein the thermally conductive filler includes boron nitride, silicon nitride, boron carbide, aluminum carbide, silicon carbide, magnesium oxide, beryllium oxide, titanium oxide, zirconium oxide, zinc oxide, aluminum trihydroxide, barium hydroxide, calcium hydroxide, dawsonite, hydrotalcite, zinc borate, calcium aluminate, zirconium oxide hydrate, or combinations thereof.

Embodiment 9 is the thermally conductive adhesive of any of embodiments 1 to 8, wherein the thermally conductive filler includes boron nitride, aluminum trihydroxide, or a combination thereof.

Embodiment 10 is the thermally conductive adhesive of any of embodiments 1 to 9, wherein the thermally conductive filler includes boron nitride.

Embodiment 11 is the thermally conductive adhesive of any of embodiments 1 to 10, including 10 wt. % to 90 wt. % of at least one solid thermally conductive filler.

Embodiment 12 is the thermally conductive adhesive of any of embodiments 1 to 11, wherein the thermally conductive filler is present in an amount of 20 to 90 wt. %, 30 to 90 wt. %, 40 to 90 wt. %, 50 to 90 wt. %, or 60 to 90 wt. % of the total thermally conductive adhesive.

Embodiment 13 is the thermally conductive adhesive of any of embodiments 1 to 12, having a thickness of 250 micrometers or greater.

Embodiment 14 is the thermally conductive adhesive of any of embodiments 1 to 13, wherein the thermally conductive filler has a surface that is not treated.

Embodiment 15 is the thermally conductive adhesive of any of embodiments 1 to 14, further including an electrically conductive filler.

Embodiment 16 is the thermally conductive adhesive of any of embodiments 1 to 15, further including a dispersant.

Embodiment 17 is the thermally conductive adhesive of any of embodiments 1 to 16, wherein the polyolefin block-containing copolymer is crosslinked.

Embodiment 18 is the thermally conductive adhesive of any of embodiments 1 to 17, exhibiting an elongation at break of 250% or greater.

Embodiment 19 is the thermally conductive adhesive of any of embodiments 1 to 18, exhibiting an elongation at break of 300% or greater.

Embodiment 20 is the thermally conductive adhesive of any of embodiments 1 to 19, exhibiting an elongation at break of 400% or greater.

Embodiment 21 is the thermally conductive adhesive of any of embodiments 1 to 20, exhibiting a through-plane thermal conductivity of 0.25 watts per meter-kelvin (W/m·K) or greater.

Embodiment 22 is the thermally conductive adhesive of any of embodiments 1 to 21, wherein the tackifier includes a C5-C9 hydrocarbon.

Embodiment 23 is the thermally conductive adhesive of any of embodiments 1 to 22, having a gel content of 10 to 90%.

Embodiment 24 is the thermally conductive adhesive of any of embodiments 1 to 23, having a gel content of 40 to 90%.

Embodiment 25 is the thermally conductive adhesive of any of embodiments 1 to 24, wherein the crosslinked pressure sensitive adhesive includes a reaction product of a composition including the polyolefin block-containing copolymer, a crosslinking agent, an initiator, and a free radical inhibitor.

Embodiment 26 is a thermally conductive article including the thermally conductive adhesive of any of embodiments 1 to 25 disposed on a substrate.

Embodiment 27 is the thermally conductive article of embodiment 26, wherein the substrate includes a release liner.

Embodiment 28 is a thermally conductive pad. The thermally conductive pad includes 10 to 50 wt. % of a polyolefin block-containing copolymer; 10 to 50 wt. % of a tackifier; and 20 to 70 wt. % of a thermally conductive filler. The polyolefin block-containing copolymer is crosslinked; the thermally conductive pad is not a pressure sensitive adhesive; and the thermally conductive pad exhibits an elongation at break of 200% or greater.

Embodiment 29 is the thermally conductive pad of embodiment 28, further including a plasticizer in an amount of 1 to 10 wt% of the total thermally conductive pad.

Embodiment 30 is the thermally conductive pad of embodiment 28 or embodiment 29, wherein the polyolefin-block comprises isoprene, ethylene, propene, butadiene, butene, octene, pentene, hexene, or a combination thereof.

Embodiment 31 is the thermally conductive pad of any of embodiments 28 to 30, wherein the polyolefin-block comprises isoprene.

Embodiment 32 is the thermally conductive pad of any of embodiments 28 to 31, wherein the polyolefin block-containing copolymer comprises styrene.

Embodiment 33 is the thermally conductive pad of any of embodiments 28 to 32, wherein the polyolefin block-containing copolymer is selected from styrene-isoprene-styrene (SIS) copolymer, styrene-butadiene-styrene (SBS) copolymer, styrene-isoprene-butadiene-styrene (SIBS) copolymer, styrene-ethylene-butadiene-styrene (SEBS) copolymer, styrene-ethylene-propylene-styrene (SEPS) copolymer, styrene-butadiene-rubber (SBR) copolymer, or a combination thereof.

Embodiment 34 is the thermally conductive pad of any of embodiments 28 to 33, wherein the polyolefin block-containing copolymer comprises styrene in an amount of 5 to 50 wt. %, 10 to 30 wt. %, or 12 to 20 wt. % of the total polyolefin block-containing copolymer.

Embodiment 35 is the thermally conductive pad of any of embodiments 28 to 34, wherein the thermally conductive filler includes a ceramic, a metal oxide, a metal hydroxide, or combinations thereof.

Embodiment 36 is the thermally conductive pad of any of embodiments 28 to 35, wherein the thermally conductive filler includes boron nitride, silicon nitride, boron carbide, aluminum carbide, silicon carbide, magnesium oxide, beryllium oxide, titanium oxide, zirconium oxide, zinc oxide, aluminum trihydroxide, barium hydroxide, calcium hydroxide, dawsonite, hydrotalcite, zinc borate, calcium aluminate, zirconium oxide hydrate, or combinations thereof.

Embodiment 37 is the thermally conductive pad of any of embodiments 28 to 36, wherein the thermally conductive filler includes boron nitride, aluminum trihydroxide, or a combination thereof.

Embodiment 38 is the thermally conductive pad of any of embodiments 28 to 37, wherein the thermally conductive filler includes boron nitride.

Embodiment 39 is the thermally conductive pad of any of embodiments 28 to 38, including 10 wt. % to 90 wt. % of at least one solid thermally conductive filler.

Embodiment 40 is the thermally conductive pad of any of embodiments 28 to 39, wherein the thermally conductive filler is present in an amount of 20 to 90 wt. %, 30 to 90 wt. %, 40 to 90 wt. %, 50 to 90 wt. %, or 60 to 90 wt. % of the total thermally conductive pad.

Embodiment 41 is the thermally conductive pad of any of embodiments 28 to 40, having a thickness of 250 micrometers or greater.

Embodiment 42 is the thermally conductive pad of any of embodiments 28 to 41, wherein the thermally conductive filler has a surface that is not treated.

Embodiment 43 is the thermally conductive pad of any of embodiments 28 to 42, further including an electrically conductive filler.

Embodiment 44 is the thermally conductive pad of any of embodiments 28 to 43, further including a dispersant.

Embodiment 45 is the thermally conductive pad of any of embodiments 28 to 44, wherein the polyolefin block-containing copolymer is crosslinked.

Embodiment 46 is the thermally conductive pad of any of embodiments 28 to 45, wherein the tackifier includes a C5-C9 hydrocarbon.

Embodiment 47 is the thermally conductive pad of any of embodiments 28 to 46, exhibiting an elongation at break of 250% or greater.

Embodiment 48 is the thermally conductive pad of any of embodiments 28 to 47, exhibiting an elongation at break of 300% or greater.

Embodiment 49 is the thermally conductive pad of any of embodiments 28 to 48, exhibiting an elongation at break of 400% or greater.

Embodiment 50 is the thermally conductive pad of any of embodiments 28 to 49, exhibiting a through-plane thermal conductivity of 0.25 watts per meter-kelvin (W/m·K) or greater.

Embodiment 51 is the thermally conductive pad of any of embodiments 28 to 50, having a gel content of 10 to 90%.

Embodiment 52 is the thermally conductive pad of any of embodiments 28 to 51, having a gel content of 40 to 90%.

Embodiment 53 is the thermally conductive pad of any of embodiments 28 to 52, wherein the thermally conductive pad includes a reaction product of a composition including the polyolefin block-containing copolymer, a crosslinking agent, an initiator, and a free radical inhibitor.

Embodiment 54 is the thermally conductive pad of embodiment 53, wherein the crosslinking agent is a UV photocrosslinker.

Embodiment 55 is the thermally conductive pad of embodiment 53 or embodiment 54, wherein the free radical inhibitor is an antioxidant.

Embodiment 56 is a method of making a thermally conductive adhesive. The method includes obtaining a composition and exposing the composition to actinic radiation to crosslink the composition and form the thermally conductive adhesive. The composition includes: 10 to 50 wt. % of a polyolefin block-containing copolymer; 10 to 50 wt. % of a tackifier; 20 to 70 wt. % of a thermally conductive filler; and a photoinitiator. The thermally conductive adhesive is a pressure sensitive adhesive and the thermally conductive adhesive exhibits an elongation at break of 200% or greater.

Embodiment 57 is the method embodiment 56, wherein the actinic radiation includes a peak wavelength between 170 nm and 500 nm, inclusive.

Embodiment 58 is the method of embodiment 56 or embodiment 57, where the actinic radiation includes an electronic beam.

Embodiment 59 is the method of any of embodiments 56 to 58, wherein the composition is essentially free of solvent.

Embodiment 60 is the method of any of embodiments 56 to 59, wherein the photoinitiator includes a benzoin ether or a substituted benzoin ether, a substituted acetophenone, a substituted alpha-ketol, an aromatic sulfonyl chloride, and a photoactive oxime, 1-hydroxy cyclohexyl phenyl ketone, bis(2,4,6-trimethylbenzoyl)phenylphosphineoxide, or combinations thereof.

Embodiment 61 is the method of any of embodiments 56 to 60, wherein the composition further includes a crosslinking agent.

Embodiment 62 is the method of embodiment 61, wherein the crosslinking agent comprises multiple (meth)acryloyl groups selected from di(meth)acrylates, tri(meth)acrylates, tetra(meth)acrylates, and penta(meth)acrylates, or combinations thereof.

Embodiment 63 is the method of any of embodiments 56 to 62, wherein the polyolefin-block comprises isoprene, ethylene, propene, butadiene, butene, octene, pentene, hexene, or a combination thereof.

Embodiment 64 is the method of any of embodiments 56 to 63, wherein the polyolefin-block comprises isoprene.

Embodiment 65 is the method of any of embodiments 56 to 64, wherein the polyolefin block-containing copolymer comprises styrene.

Embodiment 66 is the method of any of embodiments 56 to 65, wherein the polyolefin block-containing copolymer is selected from styrene-isoprene-styrene (SIS) copolymer, styrene-butadiene-styrene (SBS) copolymer, styrene-isoprene-butadiene-styrene (SIBS) copolymer, styrene-ethylene-butadiene-styrene (SEBS) copolymer, styrene-ethylene-propylene-styrene (SEPS) copolymer, styrene-butadiene-rubber (SBR) copolymer, or combinations thereof.

Embodiment 67 is the method of any of embodiments 56 to 66, wherein the polyolefin block-containing copolymer comprises styrene in an amount of 5 to 50 wt. %, 10 to 30 wt. %, or 12 to 20 wt. % of the total polyolefin block-containing copolymer.

Embodiment 68 is the method of any of embodiments 56 to 67, wherein the thermally conductive filler includes a ceramic, a metal oxide, a metal hydroxide, or combinations thereof.

Embodiment 69 is the method of any of embodiments 56 to 68, wherein the thermally conductive filler includes boron nitride, silicon nitride, boron carbide, aluminum carbide, silicon carbide, magnesium oxide, beryllium oxide, titanium oxide, zirconium oxide, zinc oxide, aluminum trihydroxide, barium hydroxide, calcium hydroxide, dawsonite, hydrotalcite, zinc borate, calcium aluminate, zirconium oxide hydrate, or combinations thereof.

Embodiment 70 is the method of any of embodiments 56 to 69, wherein the thermally conductive filler includes boron nitride, aluminum trihydroxide, or a combination thereof.

Embodiment 71 is the method of any of embodiments 56 to 70, wherein the thermally conductive filler includes boron nitride.

Embodiment 72 is the method of any of embodiments 56 to 71, wherein the thermally conductive adhesive includes 10 wt. % to 90 wt. % of at least one solid thermally conductive filler.

Embodiment 73 is the method of any of embodiments 56 to 72, wherein the thermally conductive filler is present in an amount of 20 to 90 wt. %, 30 to 90 wt. %, 40 to 90 wt. %, 50 to 90 wt. %, or 60 to 90 wt. % of the total thermally conductive adhesive.

Embodiment 74 is the method of any of embodiments 56 to 73, wherein the thermally conductive adhesive has a thickness of 250 micrometers or greater.

Embodiment 75 is the method of any of embodiments 56 to 74, wherein the thermally conductive filler has a surface that is not treated.

Embodiment 76 is the method of any of embodiments 56 to 75, wherein the thermally conductive adhesive further includes an electrically conductive filler.

Embodiment 77 is the method of any of embodiments 56 to 76, wherein the composition further includes a dispersant.

Embodiment 78 is the method of any of embodiments 56 to 77, wherein the polyolefin block-containing copolymer is crosslinked.

Embodiment 79 is the method of any of embodiments 56 to 78, wherein the thermally conductive adhesive exhibits an elongation at break of 250% or greater.

Embodiment 80 is the method of any of embodiments 56 to 79, wherein the thermally conductive adhesive exhibits an elongation at break of 300% or greater.

Embodiment 81 is the method of any of embodiments 56 to 80, wherein the thermally conductive adhesive exhibits an elongation at break of 400% or greater.

Embodiment 82 is the method of any of embodiments 56 to 81, wherein the thermally conductive adhesive exhibits a through-plane thermal conductivity of 0.25 watts per meter-kelvin (W/m·K) or greater.

Embodiment 83 is the method of any of embodiments 56 to 82, wherein the tackifier includes a C5-C9 hydrocarbon.

Embodiment 84 is the method of any of embodiments 56 to 83, wherein the thermally conductive adhesive has a gel content of 10 to 90%.

Embodiment 85 is the method of any of embodiments 56 to 84, wherein the thermally conductive adhesive has a gel content of 40 to 90%.

Embodiment 86 is the method of any of embodiments 56 to 85, wherein the pressure sensitive adhesive includes a reaction product of a composition including the polyolefin block-containing copolymer, a crosslinking agent, an initiator, and a free radical inhibitor.

Embodiment 87 is the method of any of embodiments 56 to 86, further including disposing the thermally conductive adhesive on a substrate.

Embodiment 88 is the method of embodiment 87, wherein the substrate includes a release liner.

### EXAMPLES

Unless otherwise noted, all parts, percentages, ratios, etc. in the Examples and the rest of the specification are by weight. Unless stated otherwise, all other reagents were obtained, or are available from fine chemical vendors such as Sigma-Aldrich Company, St. Louis, Mo., or may be synthesized by known methods.

Material abbreviations used in the Examples are listed in Table 1 below.

TABLE 1
Materials List

| Abbreviation | Description | Vendor |
|---|---|---|
| KD1161 | Olefin based resin obtained under the trade | Kraton (Houston, TX) |
| | designation KRATON D1161 | |
| WTP | Aromatic-modified aliphatic resin | Cray Valley (Paris, France) |
| | (tackifier) obtained under the trade | |
| | designation WINGTACK PLUS | |
| WT10 | Liquid aliphatic C-5 petroleum | Cray Valley (Paris, France) |
| | hydrocarbon obtained under the trade | |
| | designation WINGTACK 10 | |
| BN50 | Agglomerates of boron nitride (BN) | 3M (Kempten, Germany) |
| | platelets (Grade = Agglomerates 50), with | |
| | a median size of 15-30 μm; thermal | |
| | conductive filler | |
| I1010 | Phenolic primary antioxidant obtained | BASF (Ludwigshafen, Germany) |
| | under the trade designation IRGANOX | |
| | 1010 | |
| I651 | UV initiator, (2,2-Dimethoxy-1,2- | Ciba (Basel, Switzerland) |
| | diphenylethan-1-one), obtained under the | |
| | trade designation IRGACURE 651 | |

Film Fabrication

Films used in the Examples (see Tables 2 and 5) were compounded and fabricated using a 30 millimeter (mm) Werner & Pfleiderer co-rotating twin screw extruder. Components were pre-mixed, then volumetrically fed into the extruder feed throat and subjected to 300 rotations per minute (rpm) mixing The extruder, melt transport, and die temperatures were set to 204° C. for RE 1-3 and 232° C. for EX 4-5. After compounding, the material was coated directly onto polyester backing at a thickness of 0.004-0.014 inches (0.10-0.36 mm) film and covered with a polyester release liner.

UV Radiation Test Method

Both sides of the films were exposed by UV radiation with the dosage as listed in Tables 6 and 7 on a HERAEUS NOBLELIGHT FUSION UV CURING SYSTEM (Fusion UV Systems Inc., Gaithersburg, Md.), where they were exposed to UV radiation from a “D” bulb. UV exposure dosage can be adjusted by adjusting the conveyor speed, optionally together with running for multiple times and the energy output was recorded from the UVA range (320-390 nanometers (nm)) using a UV POWER PUCK II (EIT LLC, Sterling, Va.).

Gel Percentage Test Method

Aluminum mesh was wrapped around a known amount of film sample (approximately 2-3 grams (g)). The wrapped sample was then submerged in THF solvent (approximately 100 milliliters (mL)) for 60 hours under constant stirring. The sample was then removed from the solvent and the mass of the remaining sample was recorded. The gel percentage of the sample was calculated as being equal to the ratio of the mass of the remaining film to the mass of original film.

Tensile Test Method

The films were cut into 1 inch by 5 inches (2.54 centimeters (cm) by 12.7 cm) strips for yield strength, tensile strength, elongation at break tensile tests. Tensile tests were conducted on an Instron single column table top system, Model 5943 (1 kilonewton (kN) capacity), with Instron 2712-041 pneumatic action grips (1 kN capacity) (Norwood, MA) at the speed of 2 inches/minute (5.08 centimeters/minute).

180° Peel Strength Test Method

The films were cut into 1 inch by 3.5 inch (2.54 cm by 8.89 cm) strips and sandwiched between a NANOPLAST PET film (1 inch×5 inches×0.02 inch (2.54 cm×12.7 cm×0.05 cm), 3M St. Paul, Minn.) and a selected substrate (2 inch×5 inch×0.048 inch (5.08 cm×12.7 cm×0.12 cm) stainless steel, 304sst (Oakdale Precision, Oakdale, Minn.); 2 inch×5 inch× 3/16 inch (5.08 cm x 12.7 cm×0.48 cm), CLEARLEXAN Polycarbonate (Aeromat Plastics, Burnsville, Minn.); or 2 inch×5 inches× 3/16 inch (5.08 cm×12.7 cm×0.48 cm), acrylonitrile butadiene styrene, TP-BLKABS (Aeromat Plastics, Burnsville, Minn.)). The assembled samples were then passed through a 4.5 pound (2.04 kilograms (kg)) weight roller three times to laminate them together. After dwelling at room temperature for 72 hours, the 180° peel strength tests were performed on an Instron single column table top system Model 5943 (1 kN capacity), with Instron 2712-041 pneumatic action grips (1 kN capacity) (Norwood, Mass.) at the speed of 12 inches/minute (30.48 centimeters/minute). Samples were inserted into the instrument according to the Instron lab manual and the 180° test was performed. Results are reported in Newtons per millimeter (N/mm).

Static Sheer Test Method

Static shear tests were conducted on 1 inch×1 inch (2.54 cm×2.54 cm) square film adhesive samples. The square film adhesive samples were laminated between a stainless steel coupon and PET film (2 mil (0.05 mm) thick NANOPLAST PET film, 3M, St. Paul, Minn.). A 500 g weight was hung from the sample and the sample and hanging weight were placed into a chamber heated to 70° C. The time until failure (i.e., from the time the weight was hung to the time the weight fell) was recorded.

Thermal Conductivity Test Method

For thermal conductivity measurements, disk-shaped samples were made by pressing a disk-shaped mold into the cured film with a diameter of 12.6 mm and a thickness of 0.10-0.36 mm.

Specific heat capacity, cp, was measured using a Q2000 Differential Scanning Calorimeter (TA Instruments, Eden Prairie, Minn., US) with sapphire as a method standard.

Sample density was determined using a geometric method. The weight (m) of a film was measured using a standard laboratory balance, the diameter (d) of the disk was measured using calipers, and the thickness (h) of the disk was measured using a Mitatoyo micrometer. The density, ρ, was calculated by ρ=m/(π·h·(d/2)2).

Thermal conductivity measurements were conducted for both in-plane and through-plane directions. The measurements are based on the equation of λ(T)=α(T)·cp·ρ(T), where α(T), is the thermal diffusivity and was measured on the an LFA 467 HYPERFLASH Light Flash Apparatus (Netzsch Instruments, Burlington, Mass., US) according to ASTM E1461-13, “Standard Test Method for Thermal Diffusivity by the Flash Method.”

Thermal conductivity, k, was calculated from thermal diffusivity, heat capacity, and density measurements according the formula:

k=α19 cp·ρ

where k is the thermal conductivity in W/(m K), α is the thermal diffusivity in mm²/s, cp is the specific heat capacity in J/K-g, and ρ is the density in g/cm³.

Tackiness Measurement Test Method

Tackiness was measured by pressing an ungloved finger on the film adhesive, ranked by high finger tack, medium finger tack, and low finger tack.

### REFERENCE EXAMPLES 1 TO 3 (RE-1 TO RE-3)

Thermally conductive adhesives were prepared according to the formulations listed in Table 2. Films of the thermally conductive adhesives were prepared according to the Film Fabrication procedure described previously. Tackiness measurements were taken according to the Tackiness Measurement Test Method described previously. Process conditions, final film thickness, and tackiness measurements of the thermally conductive adhesives are shown in Table 2. Tensile and static sheer properties (tests performed according to the Tensile Test Method and Static Sheer Test Method above) for RE-1 to RE-3 are summarized in Table 3. Results for the 180° peel strength tests (performed as described in the 180° Peel Strength Test Method above) on stainless steel (SS), polycarbonate (PC), and acrylonitrile butadiene styrene (ABS) substrates are summarized in Table 4. Results for thermal conductivity (TC), both in-plane and through-plane, were measured according to the Thermal Conductivity Test Method described previously and are summarized in Table 4.

TABLE 2
Formulations for thermally conductive film adhesive examples RE-1 to RE-3.

| | KD1161, | WTP, | BN50, | I1010, | Process | | |
|---|---|---|---|---|---|---|---|
| EXAMPLE | wt. % | wt. % | wt. % | wt. % | Conditions | Thickness | Tackiness |
| RE-1 | 24.8% | 24.7% | 49.5% | 1% | 204° C./no | 14 mil | High Finger |
| | | | | | vacuum | (0.2 mm) | Tack |
| RE-2 | 19.8% | 19.8% | 59.4% | 1% | 204° C./no | 8 mil | High Finger |
| | | | | | vacuum | (0.36 mm) | Tack |
| RE-3 | 14.8% | 14.7% | 69.3% | 1% | 204° C./no | 8 mil | Good Finger |
| | | | | | vacuum | (0.36 mm) | Tack |

TABLE 3
Tensile properties for RE-1 to RE-3.

| | Polyolefin/ | Boron | Yield | Tensile | | 70° C./500 g |
|---|---|---|---|---|---|---|
| | Tackifier, | Nitride, | Strength, | Strength, | Elongation, | Static Shear, |
| EXAMPLE | wt. % | wt. % | N/mm² | N/mm² | % | min |
| RE-1 | 50% | 50% | 0.17 | 0.19 | 1000% | 536 |
| RE-2 | 40% | 60% | 0.28 | 0.28 | 550% | 2582 |
| RE-3 | 30% | 70% | 0.27 | 0.27 | 380% | 6342 |

TABLE 4
180° peel strength and thermal conductivity results for RE-1 to RE-3.

| | 180° Peel | 180° Peel | 180° Peel | TC In- | TC Through- |
|---|---|---|---|---|---|
| EXAM- | SS, | PC, | ABS, | Plane, | Plane, |
| PLE | N/mm | N/mm | N/mm | W/(m*K) | W/(m*K) |
| RE-1 | 1.79 | 1.73 | 1.33 | 2.91 | 0.36 |
| RE-2 | 1.06 | 1.08 | 0.85 | 4.95 | 0.41 |
| RE-3 | 0.52 | 0.44 | 0.37 | 6.27 | 0.62 |

### EXAMPLES 4 TO 5 (EX-4 TO EX-5)

UV-crosslinkable thermally conductive adhesives were prepared according to the formulations listed in Table 5. Films of the UV-crosslinkable thermally conductive adhesives were prepared according to the Film Fabrication procedure described previously. Tackiness measurements were taken according to the Tackiness Measurement Test Method described previously. Process conditions, final film thickness, and tackiness measurements of the UV-crosslinkable thermally conductive adhesives are shown in Table 5. The films were then exposed to UV radiation according to the UV Radiation Test Method described previously. Gel percentage measurements of films exposed to UV radiation are summarized in Table 6. Mechanical properties before and after UV exposure for EX-4 and EX-5 were measured according to the Tensile Test Method described above and are summarized in Table 7. Results for through-plane thermal conductivity (TC), were measured for EX-4 and EX-5 according to the Thermal Conductivity Test Method described previously, and are summarized in Table 8.

TABLE 5
Formulations for UV-crosslinkable thermally conductive film adhesive examples EX-4 and EX-5.

| | KD1161, | WTP, | WT10, | I651, | BN50, | I1010, | Process | | |
|---|---|---|---|---|---|---|---|---|---|
| EXAMPLE | wt. % | wt. % | wt. % | wt. % | wt. % | wt. % | Conditions | Thickness | Tackiness |
| EX-4 | 22% | 22% | 3% | 2% | 50% | 1% | 232° C./no | 10 mil | High |
| | | | | | | | vacuum | (0.25 mm) | Finger |
| | | | | | | | | | Tack |
| EX-5 | 17% | 17% | 3% | 2% | 60% | 1% | 232° C./no | 6 mil | Medium |
| | | | | | | | vacuum | (0.15 mm) | Finger |
| | | | | | | | | | Tack |

TABLE 6
Gel percentage and the UV dosage for EX-4 and EX-5.

| | UVA Dosage | | | | |
|---|---|---|---|---|---|
| | Gel % after | Gel % after | Gel % after | Gel % after 8000 | Gel % after 16000 |
| EXAMPLE | 0 MJ/cm² | 2000 MJ/cm² | 4000 MJ/cm² | MJ/cm² | MJ/cm² |
| EX-4 | 0.23 | 16.9 | 51.4 | 71.2 | 100 |
| EX-5 | 0.38 | 67.7 | 74.5 | 76.5 | 77.1 |

TABLE 7
Tensile properties before and after UV exposure for EX-4 and EX-5.

| | | | | | | Tensile | |
|---|---|---|---|---|---|---|---|
| | | | Tensile | | | Strength | Elongation |
| | Polyolefin/ | Boron | Strength | | | (after UV | After UV |
| | Tackifier, | Nitride, | (no UV), | Elongation | UV | radiation), | radiation), |
| EXAMPLE | wt. % | wt. % | N/mm² | (no UV), % | Dosage | N/mm² | % |
| EX-4 | 50% | 50% | 1.2 | 730% | UV 20 | 4.3 | 348% |
| | | | | | J/cm² | | |
| | | | | | one side | | |
| EX-5 | 40% | 60% | 0.86 | 412% | UV 5 | 5.0 | 232% |
| | | | | | J/cm² | | |
| | | | | | one side | | |

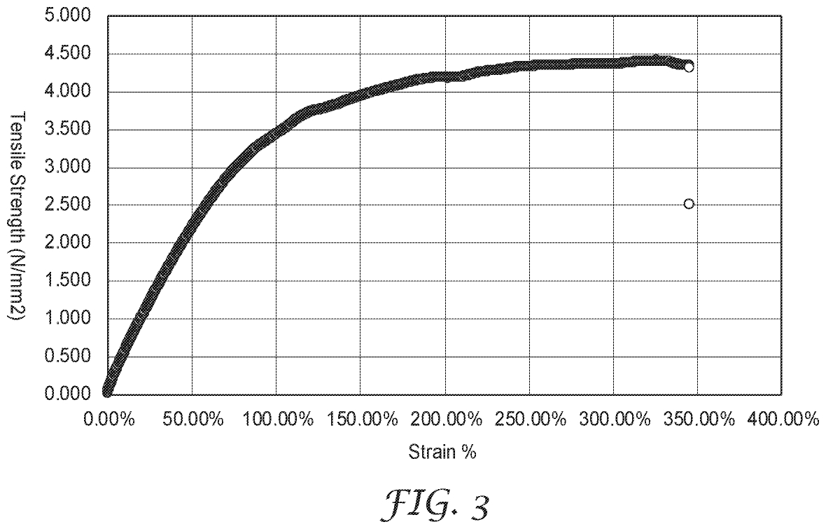

Further, FIG. 3 is a graph of elongation for EX-4, as a function of load force.

TABLE 8
Thermal conductivity results for EX-4 and EX-5.

| | | | Thermal | Thermal |
|---|---|---|---|---|
| | | Heat | Diffusivity | Conductivity |
| | Density, | Capacity, | (Through-Plane), | (Through-Plane), |
| EXAMPLE | g/mL | J/(C*g) | mm²/s | W/(m*K) |
| EX-4 | 1.33 | 1.27 | 0.16 | 0.27 |
| EX-5 | 1.46 | 1.23 | 0.19 | 0.34 |

Various modifications and alterations of this invention will become apparent to those skilled in the art without departing from the scope and spirit of this invention.

1. A thermally conductive adhesive comprising:
a. 10 to 50 wt. % of a polyolefin block-containing copolymer;
b. 10 to 50 wt. % of a tackifier; and
c. 20 to 70 wt. % of a thermally conductive filler;
wherein the thermally conductive adhesive is a crosslinked pressure sensitive adhesive and wherein the thermally conductive adhesive exhibits an elongation at break of 200% or greater.

2. The thermally conductive adhesive of claim 1, wherein the polyolefin-block comprises isoprene, ethylene, propene, butadiene, butene, octene, pentene, hexene, or a combination thereof.

3. The thermally conductive adhesive of claim 1, wherein the polyolefin block-containing copolymer comprises styrene in an amount of 5 to 50 wt. %, 10 to 30 wt. %, or 12 to 20 wt. % of the total polyolefin block-containing copolymer.

4. The thermally conductive adhesive of claim 1, wherein the thermally conductive filler comprises boron nitride, aluminum trihydroxide, or a combination thereof.

5. The thermally conductive adhesive of claims 1, having a thickness of 250 micrometers or greater.

6. The thermally conductive adhesive of claims 1, further comprising a dispersant.

7. The thermally conductive adhesive of claim 1, exhibiting a through-plane thermal conductivity of 0.25 watts per meter-kelvin (W/m·K) or greater.

8. The thermally conductive adhesive of claim 1 , comprising a gel content of 40 to 90%.

9. The thermally conductive adhesive of claim 1, wherein the crosslinked pressure sensitive adhesive comprises a reaction product of a composition comprising the polyolefin block-containing copolymer, a crosslinking agent, an initiator, and a free radical inhibitor.

10. A thermally conductive article comprising the thermally conductive adhesive of claim 1 disposed on a substrate.

11. The thermally conductive article of claim 10, wherein the substrate comprises a release liner.

12. A thermally conductive pad comprising:
a. 10 to 50 wt. % of a polyolefin block-containing copolymer;
b. 10 to 50 wt. % of a tackifier; and
c. 20 to 70 wt. % of a thermally conductive filler;
wherein the polyolefin block-containing copolymer is crosslinked; wherein the thermally conductive pad is not a pressure sensitive adhesive; and wherein the thermally conductive pad exhibits an elongation at break of 200% or greater.

13. A method of making a thermally conductive adhesive comprising:
a. obtaining a composition comprising:
i. 10 to 50 wt. % of a polyolefin block-containing copolymer;
ii. 10 to 50 wt. % of a tackifier;
iii. 20 to 70 wt. % of a thermally conductive filler; and
iv. a photoinitiator; and
b. exposing the composition to actinic radiation to crosslink the composition and form the thermally conductive adhesive, wherein the thermally conductive adhesive is a pressure sensitive adhesive and wherein the thermally conductive adhesive exhibits an elongation at break of 200% or greater.

14. The method of claim 13, wherein the composition is essentially free of solvent.

15. The method of claim 13, wherein the composition further comprises a crosslinking agent comprising multiple (meth)acryloyl groups selected from di(meth)acrylates, tri(meth)acrylates, tetra(meth)acrylates, and penta(meth) , or combinations thereof.
